(19) United States
(12) Patent Application Publication
(10) Pub. No.: US 2018/0181177 A1
(43) Pub. Date: Jun. 28, 2018

(54) ELECTRONIC APPARATUS AND METHOD FOR CONTROLLING THE SAME

(71) Applicant: CANON KABUSHIKI KAISHA, Tokyo (JP)

(72) Inventor: Ryuji Fukute, Kunitachi-shi (JP)

(21) Appl. No.: 15/847,776

(22) Filed: Dec. 19, 2017

(30) Foreign Application Priority Data
Dec. 27, 2016 (JP) 2016-254231

(51) Int. Cl. G06F 1/26; H04N 5/232; G09G 3/20; G06F 13/42

(52) U.S. Cl. CPC G06F 1/266; H04N 5/23241; G09G 3/2096; H02J 7/0052; G09G 2330/02; G09G 2370/06; G06F 13/4282

(57) ABSTRACT

An electronic apparatus according to the present disclosure is capable of transmitting and receiving power to/from a connected external apparatus. According to one embodiment, the electronic apparatus includes a CC terminal, a pull-up resistor, a pull-down resistor, a switch configured to switch between a connection of the CC terminal with the pull-up resistor and a connection of the CC terminal with the pull-down resistor, and a communication control unit configured to communicate with the external apparatus via the CC terminal. When the CC terminal connects with the external apparatus, and the connection of the CC terminal with the pull-up resistor is fixed, the communication control unit transmits, to the external apparatus, a PR SWAP message for requesting the external apparatus to enter a state where the external apparatus can supply power to the electronic apparatus.

### BACKGROUND

### Field

The present disclosure relates to an electronic apparatus capable of transmitting and receiving power and a method for controlling the electronic apparatus.

### Description of the Related Art

There is an established Universal Serial Bus (USB)3.1 standard for specifying USB Type-C for supporting the USB2.0, the USB Power Delivery (hereinafter referred to as PD), and the USB Battery Charging standards. In the USB3.1 standard, an Alternate Mode (hereinafter referred to as an Alt. mode) is designed for allowing video and sound data conforming to the Display Port and the High-Definition Multimedia Interface (HDMI®) standards to be transferred to a connected display or audio device.

The USB3.1 standard specifies, in data transmission and reception, a Downstream Facing Port (DFP) apparatus as a conventional host apparatus or an Upstream Facing Port (UFP) apparatus as a device apparatus. The USB3.1 standard specifies a Dual Role Port (DRP) apparatus having functions of both a host and a device apparatus. The USB3.1 standard enables bidirectional transmission and reception of not only data but also power. The power supplying side is referred to as a Source and the power reception side is referred to as a Sink. USB Type-C connectors have a unified connector shape on the transmission and reception sides. The above-described roles can be swapped between connected apparatuses.

Universal Serial Bus Type-C Cable and Connector Specification Revision 1.2 published by USB Implementers Forum, Inc. discusses a technique for determining the role of a connected apparatus by using a USB Type-C Configuration Channel (hereafter referred to as CC) terminal. Using this technique, the state of a DRP apparatus, i.e., a state where the apparatus functions as both a DFP apparatus and a Source (DFP/Source) or a state where the apparatus functions as both a UFP apparatus and a Sink (UFP/Sink), can be temporarily determined depending on the state of a connected external apparatus.

USB_PD_R2_0 V1.2—20160325—ECN clean markup 20160802 published by USB Implementers Forum, Inc. discusses a technique for performing Power Contract when a DRP apparatus is connected with an external apparatus in the DFP/Source state. In Power Contract, the DRP apparatus determines the amount of power supply from a Source to a Sink, together with the connected external apparatus, through communication using a CC terminal. USB_PD_R2_0 V1.2—20160325—ECN clean markup 20160802 discusses a technique for implementing PR SWAP processing for swapping the roles of a Source and a Sink.

The specification in United States Patent Publication Application No. 2016/0127671 discusses a technique characterized in that a UFP apparatus and a DFP apparatus are connected via an extension unit as a technique for implementing the Alt. mode based on the USB Type-C standard.

### SUMMARY

According to various embodiments of the present disclosure, an electronic apparatus capable of connecting with an external apparatus and transmitting and receiving power to/from the external apparatus includes a first connection terminal connectable with the external apparatus, a first resistor of which one end is connected to a first voltage terminal for outputting a first voltage, a second resistor of which one end is connected to a second voltage terminal for outputting a second voltage lower than the first voltage, a switching unit configured to switch between a first connection of the first connection terminal with the other end of the first resistor and a second connection of the first connection terminal with the other end of the second resistor, and a communication unit configured to communicate with the external apparatus via the first connection terminal. In a case that the first connection terminal is not connected with the external apparatus, the switching unit periodically switches between the first connection and the second connection. In a case that the first connection terminal is connected with the external apparatus, the switching unit fixes a connection of the first connection terminal on either the first or the second connection. In a case that the switching unit fixes the connection of the first connection terminal on the first connection, the communication unit transmits, to the external apparatus, a request signal for requesting that the external apparatus enter a state where the external apparatus is capable of supplying power to the electronic apparatus.

Further features will become apparent from the following description of exemplary embodiments with reference to the attached drawings.

### BRIEF DESCRIPTION OF THE DRAWINGS

FIG. 1 illustrates a configuration of an electronic apparatus, an external apparatus, a cable, and a battery according to one embodiment.

FIG. 2 schematically illustrates terminal arrangements of connectors according to one embodiment.

FIG. 3 is a block diagram illustrating function blocks of the electronic apparatus according to one embodiment.

FIG. 4 is a block diagram illustrating function blocks of the external apparatus.

FIG. 5 is a flowchart illustrating connection control processing according to a first exemplary embodiment.

FIG. 6 is a flowchart illustrating power reception processing according to one embodiment.

FIG. 7 is a flowchart illustrating power feed processing according to one embodiment.

FIG. 8 is a flowchart illustrating connection control processing according to a second exemplary embodiment.

FIG. 9 is a flowchart illustrating connection control processing according to a comparative example.

### DESCRIPTION OF THE EMBODIMENTS

Exemplary embodiments will be described below with reference to the accompanying drawings. While exemplary embodiments have been described, they are not limiting. The technical scope of the present disclosure is determined by the claims and is not limited by the following exemplary embodiments. Not all of the combinations of features described in the exemplary embodiments are indispensable to all embodiments. The contents of the present specification and drawings are illustrative and are not meant to limit the scope of the claims. Different embodiments can be modified in diverse ways (including organic combinations of these exemplary embodiments) without departing from the spirit and scope of the present disclosure. These modifications are not excluded from the scope of the present disclosure. More specifically, all of configurations derived by suitably combining the above-described exemplary embodiments and modifications thereof are also intended to be included in the scope of the present disclosure.

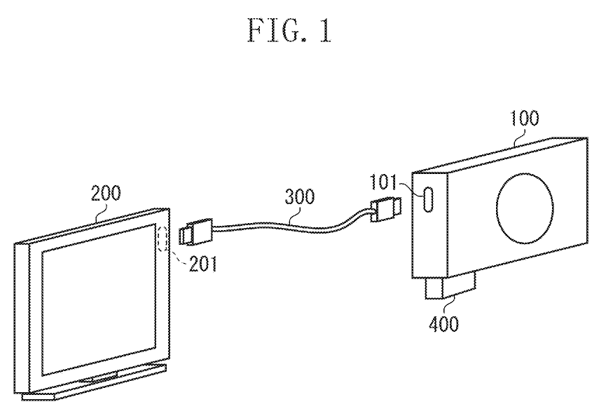

FIG. 1 illustrates an apparatus configuration according to a first exemplary embodiment, including an electronic apparatus 100, an external apparatus 200, a cable 300 for connecting the electronic apparatus 100 and the external apparatus 200, and a battery 400. For example, the electronic apparatus 100 is assumed to be a digital camera. The external apparatus 200 is assumed to be a display apparatus for displaying an image based on an image signal output from the electronic apparatus 100.

The electronic apparatus 100 is provided with a connector 101. The external apparatus 200 is provided with a connector 201. The connectors 101 and 201 are receptacles to be connected with the cable 300. The connectors 101 and 201 are both assumed to be USB Type-C receptacles. The electronic apparatus 100 is assumed to connect with the battery 400 and operate on power supplied from the battery 400.

With the decrease in remaining power of the battery 400, the electronic apparatus 100 operating on power of the battery 400 may not operate. In the past, when the electronic apparatus 100 operating on power of the battery 400 has kept supplying power to the external apparatus 200 connected thereto, remaining power of the battery 400 decreased, possibly resulting in an unstable operation of the electronic apparatus 100. Therefore, it is desirable that the electronic apparatus 100 supplies an amount of power as small as possible to the external apparatus 200 for a time period as short as possible. The electronic apparatus 100 according to the present exemplary embodiment performs connection processing (described below) to reduce the time period during which the electronic apparatus 100 supplies power to the external apparatus 200.

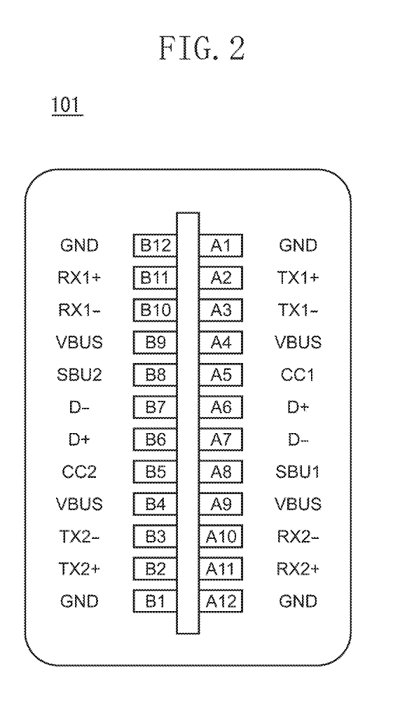

FIG. 2 schematically illustrates terminal arrangements of the connectors 101 and 201. The connectors 101 and 201 have a plurality of terminals. The connectors 101 and 201 are provided with a CC terminal for performing signal transmission and reception between apparatuses by using an alternating current (AC) signal and a direct current (DC) level of the connectors. The CC terminal is a connection terminal connectable with other apparatuses. It is assumed that, for example, information indicating whether the electronic apparatus 100 is a host apparatus or device apparatus is transmitted from the electronic apparatus 100 through signal transmission and reception by using the CC terminals. Each apparatus may determine whether the electronic apparatus 100 is a host apparatus or device apparatus depending on the state of a switch (described below). The connectors 101 and 201 are provided with a VBUS terminal for supplying a VBUS voltage from one apparatus to the other. The connectors 101 and 201 are provided with a GND terminal to be connected to the grounding terminal of each apparatus.

The cable 300 is a communication cable having plugs for connection with the connectors 101 and 201 on both ends. The cable 300 is assumed to be a cable conforming to the USB Type-C standard. The cable 300 is provided with communication lines corresponding to the terminals illustrated in FIG. 2.

The electronic apparatus 100 is a DRP apparatus conforming to the USB Type-C standard. When a DRP apparatus connects with the external apparatus 200, the DRP apparatus enters a DFP apparatus connection state where the DRP apparatus has a role of supplying power (Source) or a UFP apparatus connection state where the DRP apparatus has a role of receiving power (Sink), depending on the state of the external apparatus 200.

When the electronic apparatus 100 connects with the external apparatus 200 in conformance with the USB Type-C standard and the DFP apparatus connection state where the electronic apparatus 100 has a role of supplying power (Source) is selected, the electronic apparatus 100 applies a predetermined voltage (5 V) to the VBUS terminal. As described below, after the electronic apparatus 100 and the external apparatus 200 connect with each other, PR SWAP for swapping the role of supplying power can be performed. However, when the electronic apparatus 100 connects with the external apparatus 200 in the DFP/Source state, the electronic apparatus 100 keeps transmitting power with a predetermined voltage until PR SWAP is performed.

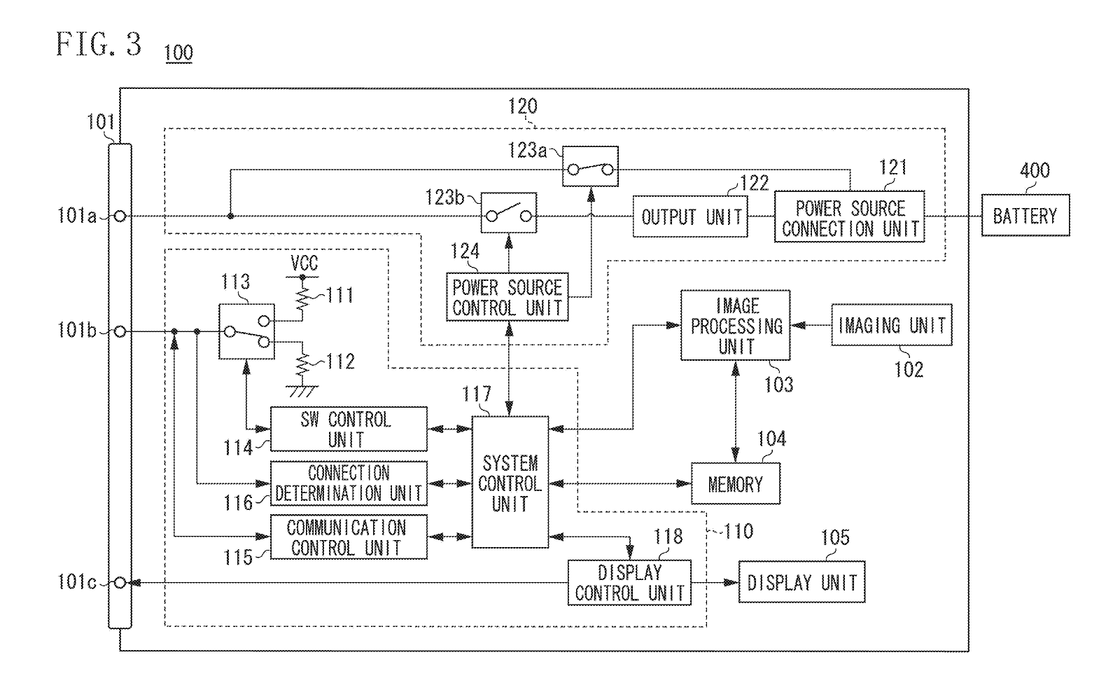

FIG. 3 is a block diagram illustrating function blocks of the electronic apparatus 100. The electronic apparatus 100 includes the connector 101, an imaging unit 102, an image processing unit 103, a memory 104, a display unit 105, a communication unit 110, and a power source unit 120. The imaging unit 102 includes an optical system including a lens for transmitting incident light from a subject to an imaging sensor, the imaging sensor, a communication unit for outputting an image signal output by the imaging sensor, and an imaging control unit for controlling the operation of each unit. The image processing unit 103 is an image processing circuit for performing predetermined processing on the image signal transmitted from the imaging unit 102 to generate image data. For example, the image processing unit 103 is assumed to be an electronic circuit substrate having a processor and an electronic circuit. The image processing unit 103 can output the generated image data to the memory 104 and the communication unit 110.

The memory 104 is a storage medium for storing data to be used by each function block of the electronic apparatus 100. For example, the memory 104 is assumed to be a Dynamic Random Access Memory (DRAM). The memory 104 may be a storage medium instead of a DRAM. The memory 104 may include a plurality of storage media. The memory 104 may include a DRAM for temporarily storing image data as intermediate data during image processing, and a nonvolatile memory such as a flash read-only memory (ROM) for storing programs executable by the processor included in the electronic apparatus 100 and adjustment values.

The display unit 105 is a display apparatus capable of displaying an image based on the image data. For example, the display unit 105 is a small liquid crystal panel, and is assumed to be disposed so that a screen is exposed to the outside of the electronic apparatus 100. The display unit 105 is controlled by a display control unit 118 included in the communication unit 110 (described below).

The communication unit 110 is a control circuit for controlling the transmission and reception of information and power to/from the external apparatus 200. The communication unit 110 includes resistors, switches, and a processor. When connection with the external apparatus 200 is detected, the communication unit 110 selects either the DFP connection state where power can be supplied to the external apparatus 200 or the UFP connection state where power can be received from the external apparatus 200, depending on the state of the external apparatus 200. When the DFP connection state is selected, the communication unit 110 requests the external apparatus 200 to supply power to the electronic apparatus 100 (Power Role SWAP and PR SWAP). Before the communication unit 110 determines whether the electronic apparatus 100 needs to receive power, the communication unit 110 transmits a PR SWAP request signal to the external apparatus 200. Operations of the communication unit 110 will be described below.

The power source unit 120 is a power control circuit to be connected with the VBUS terminal of the connector 101 and with the battery 400. The power source unit 120 controls the power supply to circuits and driving parts in the electronic apparatus 100. The power source unit 120 controls the charging of the battery 400 by using power received from the external apparatus 200.

The communication unit 110 includes a pull-up resistor 111, a pull-down resistor 112, a switch 113, a switch control unit 114, a communication control unit 115, a connection determination unit 116, a system control unit 117, and the display control unit 118.

The pull-up resistor 111 is a resistive element of which one end is connected to a constant-voltage power source for outputting a predetermined voltage value VCC and the other end is connected to the switch 113. The pull-up resistor 111 has a resistance value specified by the USB Type-C standard. For example, the resistance value of the pull-up resistor 111 is assumed to be 22 kΩ. The voltage value VCC is specified by the USB Type-C standard. For example, the voltage value VCC is assumed to be 5 V.

The pull-down resistor 112 is a resistive element of which one end is connected to the grounding (GND) terminal and the other end is connected to the switch 113. Therefore, the one end of the pull-down resistor 112 is connected to the ground potential via a resistor. The pull-down resistor 112 has a resistance value specified by the USB Type-C standard. For example, the resistance value of the pull-down resistor 112 is assumed to be 5.1 kΩ.

The switch 113 connects with the CC terminal 101b, and switches between the connection of the CC terminal 101b with the pull-up resistor 111 and the connection of the CC terminal 101b with the pull-down resistor 112 under the control of the switch control unit 114. The switch 113 switch a connection of the CC terminal 101b between a connection of the CC terminal 101b with an other end of the pull-up resistor 111 (a first connection), and a connection of the CC terminal 101b with an other end of the pull-down resistor 112 (a second connection).

The switch control unit 114 is a control circuit for controlling the switch 113 to select a resistor to be connected to the CC terminal 101b. The switch control unit 114 is assumed to control the switch 113 to alternately connect the CC terminal 101b with the pull-up resistor 111 and the pull-down resistor 112 at predetermined intervals until the connection determination unit 116 determines that the CC terminal 101b is connected with the external apparatus 200.

The switch control unit 114 controls the switch 113 to select either one of the pull-up resistor 111 and the pull-down resistor 112 as a resistor to be connected to the CC terminal 101b depending on the state of the external apparatus 200 with which the electronic apparatus 100 is connected. More specifically, when the connection determination unit 116 determines that the CC terminal 101b is connected with the external apparatus 200, the switch control unit 114 stops the periodical connection switching. The resistor connected when the switch 113 stops the periodical connection switching is the resistor selected by the switch control unit 114 as a resistor to be connected to the CC terminal 101b.

When the switch control unit 114 selects the pull-up resistor 111 as a resistor to be connected to the CC terminal 101b, the electronic apparatus 100 connects with the external apparatus 200 as a DFP apparatus conforming to the USB Type-C standard. When the switch control unit 114 selects the pull-down resistor 112 as a resistor to be connected to the CC terminal 101b, the electronic apparatus 100 connects with the external apparatus 200 as a UFP apparatus conforming to the USB Type-C standard. Therefore, it can be said that the switch control unit 114 selects the connection state of the electronic apparatus 100 depending on the state of connected external apparatus 200.

The communication control unit 115 is a communication control circuit for controlling the voltage of the CC terminal 101b in order to transmit and receive information to/from the external apparatus 200. The communication control unit 115 performs communication conforming to the USB Type-C Power Delivery (PD) standard. The communication control unit 115 performs communication conforming to the USB Type-C standard by using the DC level of the CC terminal 101b. After the connection is established, the communication control unit 115 tentatively performs transmission and reception to determine whether message exchange in the PD communication is successful. When message exchange is successful, the communication control unit 115 determines that both apparatuses conform to the PD standard, and subsequently performs control using the PD communication. On the other hand, when message exchange in the PD communication is not successful, the communication control unit 115 determines that at least either one apparatus does not conform to the PD standard. In a case where at least either one apparatus does not conform to the PD standard, the Alt. mode cannot be used. The electronic apparatus 100 and the external apparatus 200 according to the present exemplary embodiment are assumed to conform to the PD standard.

The connection determination unit 116 is a connection control circuit for determining whether the external apparatus 200 is connected to the CC terminal 101b. The connection determination unit 116 outputs a result of the determination to the system control unit 117.

When the voltage of the CC terminal 101b falls within a predetermined range, the connection determination unit 116 determines that the external apparatus 200 is connected to the CC terminal 101b. More specifically, the connection determination unit 116 determines whether the voltage Vₛ of the CC terminal 101b detected satisfies the formula 1.

Vₘᵢₙ≤Vₛ<Vₘₐₓ (1)

For example, it is assumed that Vₘᵢₙ is 0.2 V and Vₘₐₓ is 2.04 V. Vₘᵢₙ and Vₘₐₓ may be values which indicate the voltage range specified by the USB Type-C standard.

When the voltage of the CC terminal 101b does not fall within a predetermined range, the connection determination unit 116 determines that the external apparatus 200 is not connected to the connector 101. For example, when no apparatus is connected to the CC terminal 101b which is connected to the pull-up resistor 111 via the switch 113, the voltage value of the CC terminal 101b is VCC. When no apparatus is connected to the CC terminal 101b which is connected to the pull-down resistor 112 via the switch 113, the voltage value of the CC terminal 101b is GND (0 V). Therefore, since neither case satisfies the range of the formula 1, the connection determination unit 116 determines that the external apparatus 200 is not connected to the CC terminal 101b.

The system control unit 117 is a control circuit for controlling the switch control unit 114, the communication control unit 115, the connection determination unit 116, and the display control unit 118. The system control unit 117 acquires information output from each control unit and outputs a signal for controlling the operation of each control unit. For example, the system control unit 117 is assumed to output information indicating whether to continue the switching control of the switch 113 to the switch control unit 114 based on information indicating a result of determining whether the external apparatus 200 is connected to the CC terminal 101b acquired from the connection determination unit 116. More specifically, the system control unit 117 controls the switch control unit 114 to fix a resistor to be connected to the CC terminal 101b when the CC terminal 101b connects with the external apparatus 200.

After the CC terminal 101b connects with the external apparatus 200, the system control unit 117 acquires information indicating a resistor connected to the CC terminal 101b to determine whether the electronic apparatus 100 connects with the external apparatus 200 as a DFP apparatus or as a UFP apparatus. The system control unit 117 outputs, to the power source unit 120, information indicating whether the electronic apparatus 100 connects with the external apparatus 200 as a DFP apparatus or UFP apparatus.

When the electronic apparatus 100 connects with the external apparatus 200 as a DFP apparatus, the system control unit 117 controls the communication control unit 115 to output a PR SWAP signal to the external apparatus 200 before determining whether the electronic apparatus 100 needs to receive power. The PR SWAP signal conforms to the USB Type-C Power Delivery standard.

When the external apparatus 200 accepts the PR SWAP signal, the system control unit 117 determines whether the electronic apparatus 100 needs to receive power. More specifically, the system control unit 117 acquires the voltage value of the battery 400 from the power source unit 120 and determines whether the voltage value of the battery 400 is insufficient for the power supplying to each device of the electronic apparatus 100. When the voltage value is determined to be insufficient, the system control unit 117 determines that the electronic apparatus 100 needs to receive power. The system control unit 117 outputs, to the power source unit 120, a result of determining whether the electronic apparatus 100 needs to receive power.

The display control unit 118 disposed in the system control unit 117 is a control circuit for transmitting image data to the display unit 105 or to the external apparatus 200 connected via the connector 101. The display control unit 118 transmits image data to the external apparatus 200 via the Tx terminal 101c and the Rx terminal 101d of the connector 101 in the Alt. mode. When displaying an image on the display unit 105, the display control unit 118 may control the display unit 105 based on image data.

The power source unit 120 includes a power source connection unit 121, an output unit 122, switches 123, and a power source control unit 124. The power source connection unit 121 connecting with the battery 400 is a power source interface for supplying and receiving power to/from the battery 400.

The output unit 122 is an output circuit for outputting power acquired from the power source connection unit 121 to circuits, operating parts, and other various devices in the electronic apparatus 100. When a switch 123 is ON, the output unit 122 outputs power to the external apparatus 200 via a VBUS terminal 101a. The output unit 122 is assumed to adjust the voltage according to the power supplying destination apparatus.

The switches 123 switch between the connection of the VBUS terminal 101a with the output unit 122 and the connection of the VBUS terminal 101a with the power source connection unit 121. The switches 123 switch the connection of the VBUS terminal 101a under the control of the power source control unit 124.

The power source control unit 124 is a control circuit for controlling the switching of the switches 123. Upon acquiring, from the communication unit 110, a signal indicating that the electronic apparatus 100 is connected with the external apparatus 200 as a DFP apparatus, the power source control unit 124 controls the switches 123 to connect the VBUS terminal 101a and the output unit 122. Upon acquisition of a signal indicating that PR SWAP with the external apparatus 200 is successful and power reception is required, the power source control unit 124 controls the switches 123 to connect the VBUS terminal 101a and the power source connection unit 121.

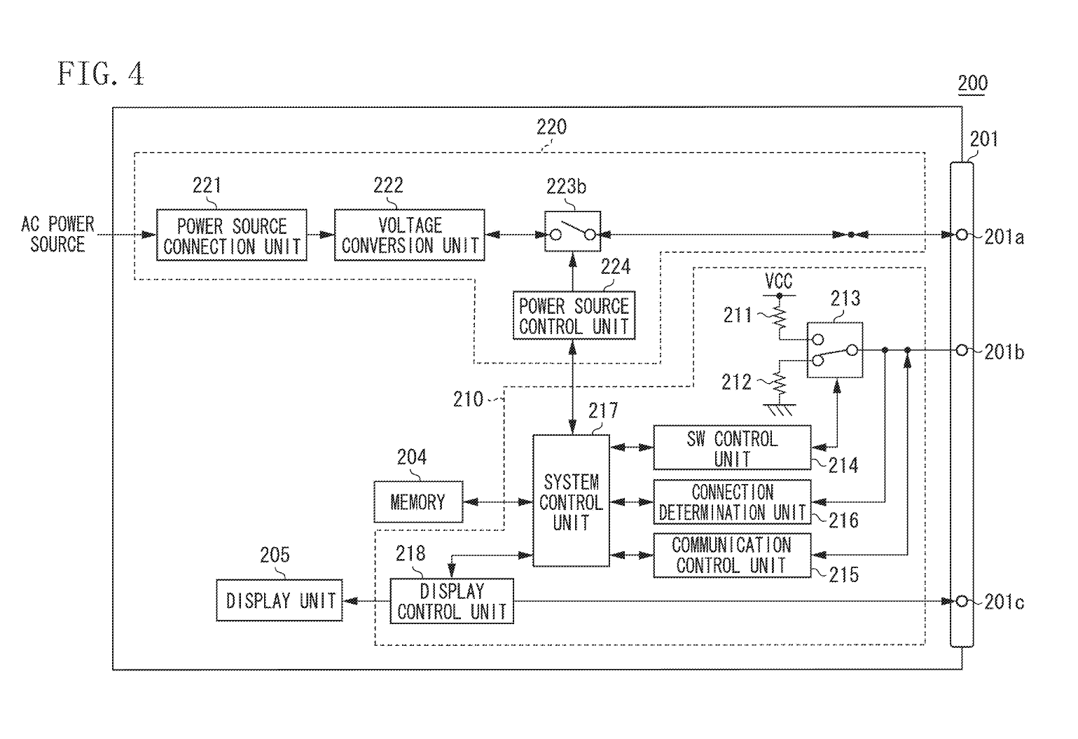

The external apparatus 200 will be described below. FIG. 4 is a block diagram illustrating function blocks of the external apparatus 200. The external apparatus 200 includes a connector 201, a memory 204, a display unit 205, a communication unit 210, and a power source unit 220. The communication unit 210 includes a pull-up resistor 211, a pull-down resistor 212, a switch 213, a switch control unit 214, a communication control unit 215, a connection determination unit 216, a system control unit 217, and a display control unit 218.

The pull-up resistor 211, the pull-down resistor 212, the switch 213, the switch control unit 214, and the display control unit 218 exhibit similar functions to those of the corresponding function blocks of the electronic apparatus 100, and redundant descriptions thereof will be omitted.

The communication control unit 215 is a communication control circuit for controlling the voltage of a CC terminal 201b in order to transmit and receive information to/from the electronic apparatus 100. The communication control unit 215 receives a PD signal transmitted from the electronic apparatus 100 via the CC terminal 201b.

The connection determination unit 216 is a connection control circuit for determining whether the electronic apparatus 100 is connected to the CC terminal 201b. The connection determination unit 216 outputs a determination result to the system control unit 217. The determination method of the connection determination unit 216 is similar to that of the connection determination unit 116 of the electronic apparatus 100, and redundant descriptions thereof will be omitted.

The system control unit 217 is a control circuit for controlling operations of the control units of the communication unit 210 and the power source unit 220. The system control unit 217 controls the operation of the power source unit 220 according to the contents of the PD communication of the electronic apparatus 100 received via the communication control unit 215. For example, upon acquisition of the PR SWAP request signal from the electronic apparatus 100, the system control unit 217 outputs a PR SWAP acceptance signal.

The power source unit 220 exhibits a similar function to that of the power source unit 120 of the electronic apparatus 100, and redundant descriptions thereof will be omitted.

The CC terminal 201b of the external apparatus 200 is connected to GND via the pull-down resistor 212. In a case where the electronic apparatus 100 and the external apparatus 200 are connected via the cable 300, when the switch 113 of the electronic apparatus 100 connects the CC terminal 101b and the pull-down resistor 112, the CC terminal 101b connects to GND of each apparatus and therefore the voltage of the CC terminal 101b becomes close to 0 V. In this case, since the voltage of the CC terminal 101b does not fall within the predetermined range, the connection determination unit 116 determines that the external apparatus 200 is not connected to the CC terminal 101b.

When the switch 113 of the electronic apparatus 100 connects the CC terminal 101b and the pull-up resistor 111, the CC terminal 101b connects the constant-voltage power source of the electronic apparatus 100 and GND of external apparatus 200. In this case, the voltage of the CC terminal 101b becomes about 1 V or less. Therefore, since the voltage of the CC terminal 101b falls within the predetermined range, the connection determination unit 116 determines that the external apparatus 200 is connected to the CC terminal 101b.

When the connection determination unit 116 determines that the CC terminal 101b is connected with the external apparatus 200, the switch control unit 114 stops the processing for periodically switching between resistors to be connected to the CC terminal 101b, and selects a resistor to be connected to the CC terminal 101b. In this case, the switch control unit 114 selects the pull-up resistor 111 as a resistor to be connected to the CC terminal 101b.

When the switch control unit 114 selects the pull-up resistor 111 as a resistor to be connected to the CC terminal 101b, the electronic apparatus 100 connects with the external apparatus 200 as a DFP apparatus conforming to the USB Type-C standard. In the state where the electronic apparatus 100 connects with the external apparatus 200 as a DFP apparatus, power can be supplied to the power supplying destination apparatus. USB_PD_R 2_0 V1.2 published by USB Implementers Forum, Inc. describes that the electronic apparatus 100 supplies 5 V power via the VBUS terminal 101a when the electronic apparatus 100 connects with the external apparatus 200 as a DFP apparatus.

However, in a case where the electronic apparatus 100 operates on a battery according to the present exemplary embodiment, the electronic apparatus 100 may not have sufficient power for supplying power to the connected external apparatus 200. In such a case, for example, the system control unit 117 determines whether the electronic apparatus 100 needs to receive power from the external apparatus 200. When the system control unit 117 determines that the electronic apparatus 100 needs to receive power from the external apparatus 200, PR SWAP is performed to swap the apparatus for supplying power.

However, in the above-described processing, since the system control unit 117 performs PR SWAP after determining whether the electronic apparatus 100 needs to receive power, there is a case where 5 V power is transmitted to the external apparatus 200 until PR SWAP is completed. If the electronic apparatus 100 not having sufficient power for supplying power to a connected external apparatus supplies power to the external apparatus 200, power for driving the electronic apparatus 100 is reduced, possibly resulting in an unstable operation.

According to the present exemplary embodiment, when a connection state where power supplying is possible is selected depending on the state of the connected external apparatus 200, the electronic apparatus 100 performs processing for requesting to perform PR SWAP at least before determining whether the electronic apparatus 100 needs to receive power. This restricts the time period during which power is supplied from the electronic apparatus 100 to the external apparatus 200, thus preventing the reduction in power for driving the electronic apparatus 100.

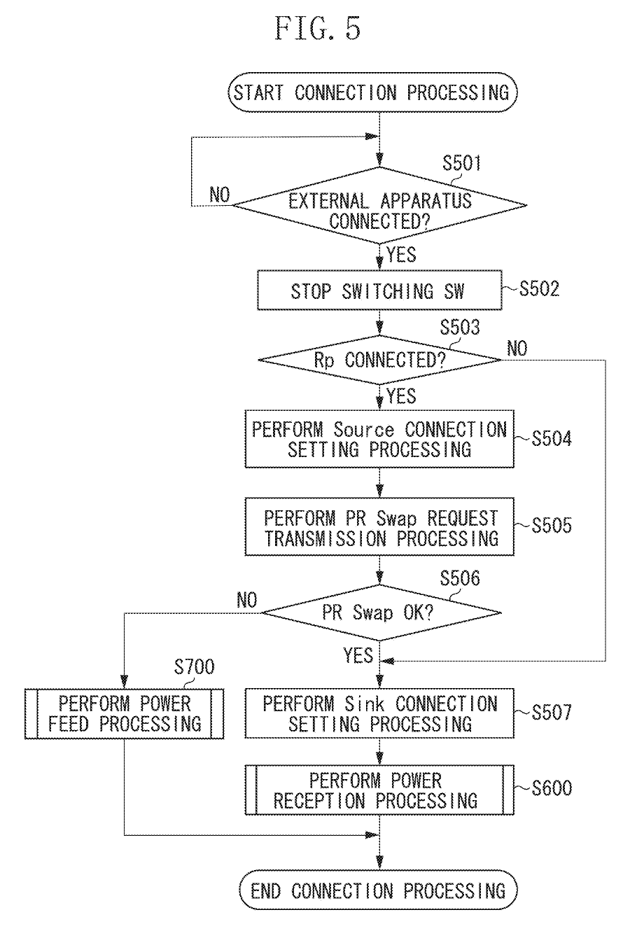

Control performed by the electronic apparatus 100 according to the present exemplary embodiment will be described in detail below. FIG. 5 is a flowchart illustrating connection control processing performed by the system control unit 117 of the electronic apparatus 100 when the electronic apparatus 100 and the external apparatus 200 are connected with each other. This flowchart is assumed to be started in a state where the electronic apparatus 100 is not connected with the external apparatus 200. In this case, the switch control unit 114 controls the switch 113 to periodically switch between resistors to be connected to the CC terminal 101b.

In step S501, the connection determination unit 116 performs processing for detecting the voltage of the CC terminal 101b to determine whether the external apparatus 200 is connected. When the voltage of the CC terminal 101b detected by the connection determination unit 116 does not fall within the predetermined range (NO in step S501), the connection determination unit 116 determines that the external apparatus 200 is not connected, and repeats the processing in step S501. On the other hand, when the voltage of the CC terminal 101b detected by the connection determination unit 116 falls within the predetermined range (YES in step S501), the connection determination unit 116 determines that the external apparatus 200 is connected. Then, the processing proceeds to step S502.

When the connection determination unit 116 determines that the CC terminal 101b and the external apparatus 200 are connected, then in step S502, the system control unit 117 transmits an instruction for stopping the switching control of the switch 113 to the switch control unit 114. Upon reception of the stop instruction, the switch control unit 114 stops the switching control of the switch 113. The connected external apparatus is assumed to be the external apparatus 200. More specifically, in step S502, the system control unit 117 fixes a resistor to be connected to the CC terminal 101b.

In step S503, the system control unit 117 determines whether the CC terminal 101b is connected with the pull-up resistor (Rp) 111. The system control unit 117 acquires, from the switch control unit 114, information indicating which resistor is connected to the CC terminal 101b via the switch 113 to determine whether the CC terminal 101b is connected with the pull-up resistor (Rp) 111.

When the CC terminal 101b is connected with the pull-up resistor (Rp) 111 (YES in step S503), the electronic apparatus 100 connects with the external apparatus 200 in the DFP apparatus connection state. In the DFP apparatus connection state, power can be transmitted to the connected external apparatus 200. Then, the processing proceeds to step S504.

When the CC terminal 101b is not connected with the pull-up resistor (Rp) 111 (NO in step S503), the CC terminal 101b is connected with the pull-down resistor (Rp) 112. In this case, the electronic apparatus 100 connects with the external apparatus 200 in the UFP apparatus connection state. In the UFP apparatus connection state, power can be received from the connected external apparatus 200. Then, the processing proceeds to step S507.

A series of processing in steps S501 to S503 is said to be processing performed by the system control unit 117 to select a connection state where the electronic apparatus 100 connects with the external apparatus 200 from the DFP apparatus connection state and the UFP apparatus connection state depending on the state of the connected external apparatus 200. More specifically, the system control unit 117 selects, as a connected resistor, the resistor that is connected to the CC terminal 101b via the switch 113 when the system control unit 117 determines that the external apparatus 200 is connected to the CC terminal 101b, and then stops the switching control of the switch 113.

In step S504, the system control unit 117 performs Source connection setting processing. The system control unit 117 controls the power source control unit 124 to open the switch 123a and close the switch 123b. As a result, the power source unit 120 enters a state where power output from the battery 400 can be supplied to the external apparatus 200 via the VBUS terminal 101a. For example, in a case where the output unit 122 is outputting a predetermined voltage (5 V), 5 V power is supplied from the VBUS terminal 101a to the external apparatus 200 upon completion of the processing in step S504. Then, the processing proceeds to step S505.

In step S505, the system control unit 117 transmits a signal to the communication control unit 115 to instruct the communication control unit 115 to output a request signal (PR SWAP message) to the external apparatus 200 via the CC terminal 101b. The PR SWAP message requests the external apparatus 200 to swap the role of transmitting power (PR SWAP). In response to the instruction signal, the communication control unit 115 performs processing for transmitting the PR SWAP message. The system control unit 117 successively performs the processing in steps S502 to S505. Therefore, the processing for transmitting the PR SWAP message can be said to be performed when the resistor connected to the CC terminal 101b is fixed.

In the power reception processing S600 (described below), the system control unit 117 performs power reception determination processing for determining whether the electronic apparatus 100 needs to be supplied with power from the external apparatus 200. It is desirable that the processing for transmitting the PR SWAP request signal is performed before the power reception determination processing. Then, the processing proceeds to step S506.

In step S506, the system control unit 117 determines whether the connected external apparatus 200 accepts the PR SWAP request. An acceptance signal indicating whether the external apparatus 200 accepts the PR SWAP request is assumed to be input to the communication control unit 115 via the CC terminal 101b. When the connected external apparatus 200 accepts the PR SWAP request (YES in step S506), the processing proceeds to step S507. In step S507, the system control unit 117 performs Source/Sink swap processing. When the connected external apparatus 200 does not accept (rejects) the PR SWAP request (NO in step S506), the processing proceeds to step S700.

In step S507, the system control unit 117 performs Sink connection setting processing. The system control unit 117 controls the power source control unit 124 to open the switches 123a and 123b. This prevents the transmission of power of the battery 400 from the power source unit 120 to the external apparatus 200. Then, the processing proceeds to step S600.

When the connected external apparatus 200 accepts the PR SWAP request (YES in step S506), then in step S507, the switch control unit 114 controls the switch 113 to connect the CC terminal 101b and the pull-down resistor 112. The switch control unit 214 of the external apparatus 200 controls the switch 213 to connect the CC terminal 201b and the pull-down resistor 212.

In step S600, the system control unit 117 performs power reception processing in which the electronic apparatus 100 receives power transmitted from the external apparatus 200. The power reception processing will be described in detail below. The power reception processing includes the power reception determination processing for determining whether the electronic apparatus 100 needs to be supplied with power from the external apparatus 200.

In step S700, the system control unit 117 performs power supply processing in which the electronic apparatus 100 transmits power to the external apparatus 200. The power supply processing will be described in detail below. When the power reception processing (S600) or the power supply processing (S700) is completed, the connection processing ends.

As described below, the power reception processing (S600) or the power supply processing (S700) ends upon cancellation of the connection between the electronic apparatus 100 and the external apparatus 200 via the CC terminal 101b. Upon completion of the connection processing, the system control unit 117 instructs the switch control unit 113 to restart periodically switching between the connection of the CC terminal 101b with the pull-up resistor 111 and the connection of the CC terminal 101b with the pull-down resistor 112.

According to the present exemplary embodiment, when the electronic apparatus 100 connects with the external apparatus 200 and switching of a resistor to be connected to the CC terminal 101b is stopped, the system control unit 117 transmits the PR SWAP request signal to the external apparatus 200. This makes it possible, when the electronic apparatus 100 connects with the external apparatus 200 in the DFP apparatus connection state, to reduce power to be transmitted until the apparatus having the role of supplying power is changed to the external apparatus 200.

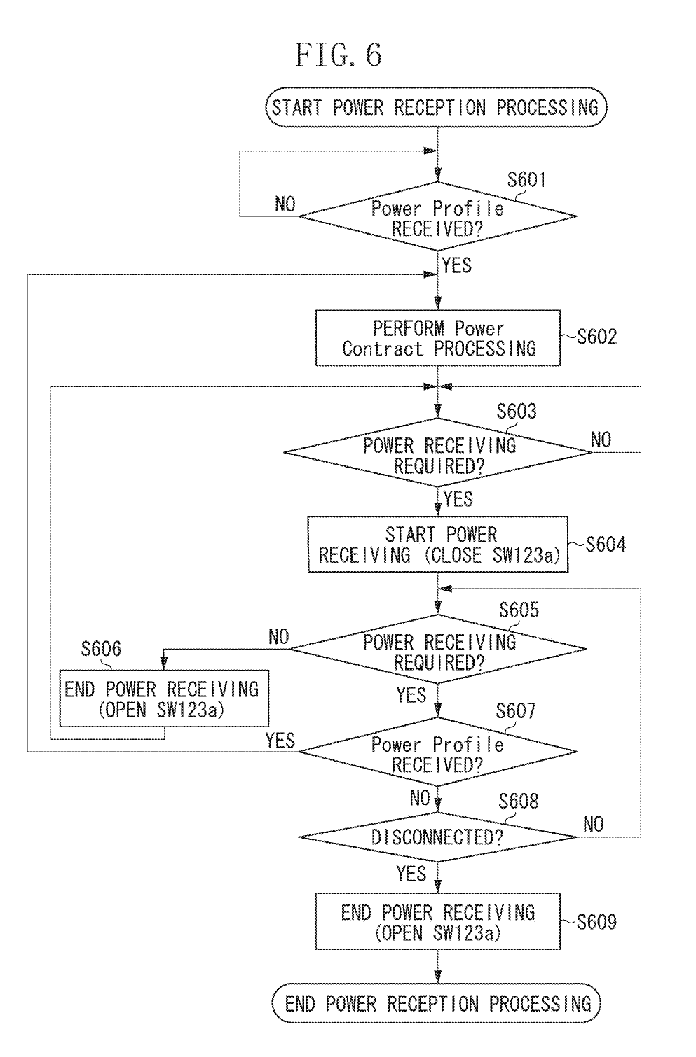

FIG. 6 is a flowchart illustrating the power reception processing performed by the system control unit 117 of the electronic apparatus 100. It is assumed that the power reception processing is performed, for example, at the timing of step S600 in the flowchart illustrated in FIG. 5.

In step S601, the system control unit 117 determines whether Power Profile transmitted from the connected external apparatus 200 is received. Power Profile is information indicating power that can be output by the external apparatus 200, for example, a Source Capabilities Message conforming to the USB-TypeC PD standard. For example, Power Profile is assumed to be a list of voltages and currents settable to the VBUS terminal 201a. When the communication control unit 115 acquires Power Profile via the CC terminal 101b, the communication control unit 115 transmits Power Profile to the system control unit 117. Then, the system control unit 117 determines that Power Profile has been received.

When the system control unit 117 determines that Power Profile transmitted from the connected external apparatus 200 has been received (YES in step S601), the processing proceeds to step S602. On the other hand, when the system control unit 117 determines that Power Profile transmitted from the connected external apparatus 200 has not been received (NO in step S601), the processing returns to step S601. Then, the system control unit 117 waits until Power Profile is transmitted.

In step S602, the system control unit 117 performs Power Contract for determining the conditions of power to be received, together with the external apparatus 200. More specifically, the system control unit 117 selects a combination of required voltage and current out of the voltages and currents indicated in the received Power Profile, and transmits the selected combination to the external apparatus 200. For example, the system control unit 117 is assumed to select the smallest power out of powers indicated in the received Power Profile and transmits the smallest power to the external apparatus 200. Upon completion of Power Contract, the external apparatus 200 starts transmitting power. Then, the processing proceeds to step S603.

In step S603, the system control unit 117 performs the power reception determination processing for determining whether the electronic apparatus 100 or the battery 400 needs to receive power. For example, the system control unit 117 communicates with the power source control unit 124 to acquire the voltage value of the battery 400. The system control unit 117 determines whether the electronic apparatus 100 needs to receive power from the external apparatus 200, i.e., whether it is necessary to charge the battery 400 having a small residual capacity.

When the voltage value of the battery 400 is a predetermined threshold value or less, the system control unit 117 determines that the electronic apparatus 100 needs to receive power. For example, the predetermined threshold value is assumed to be a voltage value for operating the electronic apparatus 100 by using power of the battery 400 plus a margin. When the system control unit 117 determines that either the electronic apparatus 100 or the battery 400 needs to receive power (YES in step S603), the processing proceeds to step S604. On the other hand, the system control unit 117 determines that neither the electronic apparatus 100 nor the battery 400 needs to receive power (NO in step S603), the processing returns to step S603 again. In step S603, the system control unit 117 performs the power reception determination processing again.

In step S604, the system control unit 117 instructs the power source control unit 124 to change the switch 123a to the connection state. In response to the instruction, the power source control unit 124 changes the switch 123a to the connection state. When the switch 123a changes to the connection state, the electronic apparatus 100 receives, via the VBUS terminal 101a, power transmitted from the external apparatus 200. The received power is input to the battery 400 via the power source connection unit 121. Then, the processing proceeds to step S605.

In step S605, the system control unit 117 performs the power reception determination processing again. After the power reception processing started in step S604, the voltage of the battery 400 becomes the predetermined threshold value or larger, making the power reception no longer necessary. In this case, the system control unit 117 performs the processing in step S605 to prevent the external apparatus 200 from transmitting unnecessary power. This makes it possible to restrict the consumption of the battery 400 of the external apparatus 200 when the external apparatus 200 operates on the battery 400. When the system control unit 117 determines that the electronic apparatus 100 does not need to receive power (NO in step S605), the processing proceeds to step S606. On the other hand, when the system control unit 117 determines that the electronic apparatus 100 needs to receive power (YES in step S605), the processing proceeds to step S607.

In step S606, the system control unit 117 instructs the power source control unit 124 to change the switch 123a to the open state. In response to the instruction, the power source control unit 124 changes the switch 123a to the open state. This prevents power transmitted from the external apparatus 200 from being input to the battery 400 of the electronic apparatus 100, and the power reception stops. Then, the processing returns to step S603. In step S603, the system control unit 117 performs processing to start the power reception when the electronic apparatus 100 needs to receive power again.

In step S607, the system control unit 117 determines whether a new Power Profile is received from the external apparatus 200. When a new Power Profile is received (YES in step S607), power that can be transmitted from the external apparatus 200 may have changed. Then, the processing returns to step S602. In step S602, the system control unit 117 performs Power Contract again. When a new Power Profile is not received from the external apparatus 200 (NO in step S607), the processing proceeds to step S608.

In step S608, the system control unit 117 determines whether the connection with the external apparatus 200 is continued. The connection determination unit 116 continuously monitors the voltage of the CC terminal 101b. When the connection determination unit 116 determines that the voltage of the CC terminal 101b does not fall within a predetermined range, the connection determination unit 116 transmits a signal indicating that the connection is not detected to the system control unit 117. When the system control unit 117 determines that the connection with the external apparatus 200 is continued (NO in step S608), the processing returns to step S605. Then, the system control unit 117 performs the power reception determination processing again. When the system control unit 117 determines that the connection with the external apparatus 200 is discontinued (YES in step S608), the processing proceeds to step S609.

In step S609, the system control unit 117 instructs the power source control unit 124 to change the switch 123a to the open state. The details of the processing in step S609 are similar to those of the processing in step S606. Then, the system control unit 117 ends the power reception processing.

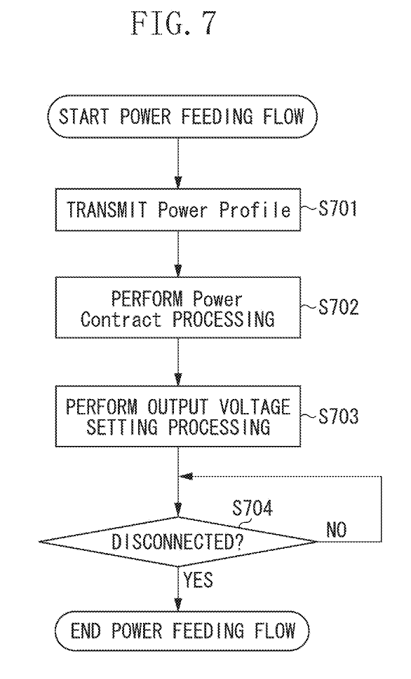

Power supply processing will be described below. FIG. 7 is a flowchart illustrating the power supply processing performed by the system control unit 117 of the electronic apparatus 100. It is assumed that the power supply processing is performed, for example, at the timing of step S700 in the flowchart illustrated in FIG. 5.

In step S701, the system control unit 117 performs processing for transmitting Power Profile to the connected external apparatus 200. The system control unit 117 instructs the communication control unit 115 to transmit Power Profile to the external apparatus 200 via the CC terminal 101b. In response to the instruction, the communication control unit 115 transmits Power Profile to the external apparatus 200. When the electronic apparatus 100 is operating on power supplied from the battery 400, the system control unit 117 is assumed to present the lowest power out of settable powers.

In step S702, the system control unit 117 performs Power Contract together with the external apparatus 200. Upon acquisition of information indicating power of which reception is requested by the external apparatus 200, transmitted from the connected external apparatus 200, the system control unit 117 completes the contract on the power transmission and reception.

In step S703, based on the information acquired in step S702, the system control unit 117 controls the power source control unit 124 to set the voltage to be output to the external apparatus 200 via the VBUS terminal 101a.

In step S704, the system control unit 117 determines whether the connection with the external apparatus 200 is continued. The method for determining the connection with the external apparatus 200 is similar to that in step S608, and redundant descriptions thereof will be omitted. When the system control unit 117 determines that the connection with the external apparatus 200 is continued (NO in step S704), the system control unit 117 repeats the processing in step S704. On the other hand, when the system control unit 117 determines that the connection with the external apparatus 200 is discontinued (YES in step S704), the system control unit 117 ends the power supply processing.

As a comparison with the above-described processing, the following describes connection processing in a case where PR SWAP is performed when the electronic apparatus 100 connects, as a DFP apparatus, with the external apparatus 200 and it is determined that the electronic apparatus 100 needs to receive power in the power reception determination processing.

When the electronic apparatus 100 as a DRP apparatus connects with the external apparatus 200 in the DFP/Source state, the electronic apparatus 100 needs to perform PR SWAP to become a Sink in order to receive power. However, power may be supplied from the electronic apparatus 100 to the external apparatus 200 before the electronic apparatus 100 performs PR SWAP. For example, in a case where the electronic apparatus 100 is operating on a small capacity battery, the electronic apparatus 100 consumes power of the battery, possibly resulting in an unstable operation of the electronic apparatus 100. Such an operation will be described below with reference to a comparative example.

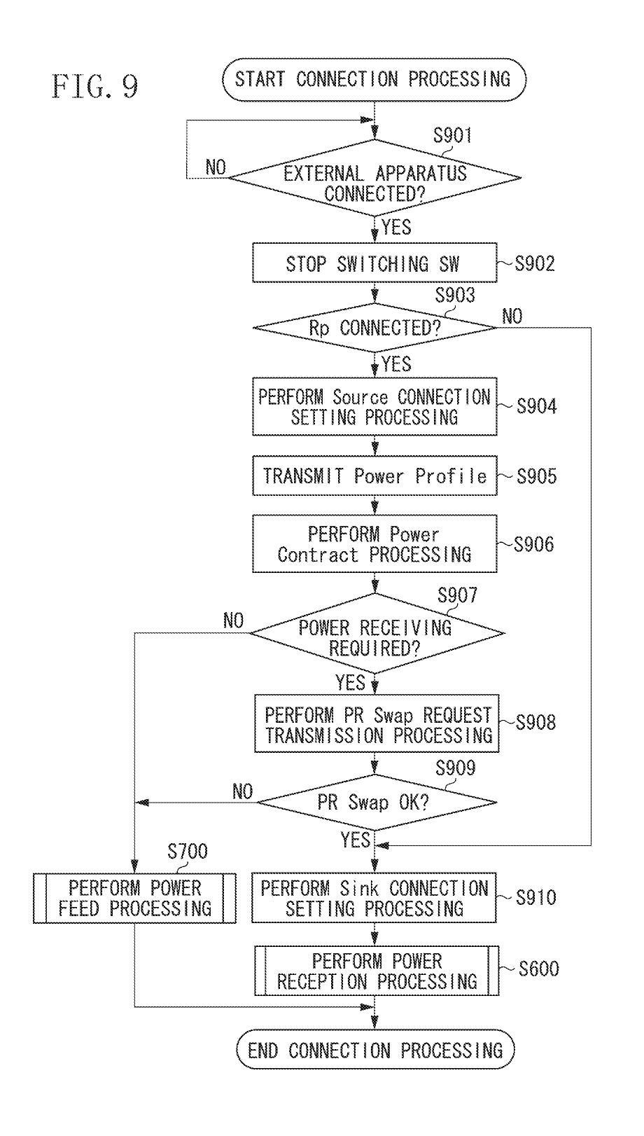

FIG. 9 is a flowchart illustrating connection processing according to the comparative example. Processing in this flowchart is similar to the processing in the flowcharts illustrated in FIGS. 5, 6, and 7, and detailed descriptions thereof will be omitted. Processing in steps S901 to S904 is similar to the processing in steps S501 to S504, respectively.

After completion of the processing in step S904, then in step S905, the system control unit 117 performs processing for transmitting Power Profile to the connected external apparatus 200. Processing in this step is similar to the processing in step S701, and redundant descriptions thereof will be omitted. In step S906, the system control unit 117 performs Power Contract. Processing in this step is similar to the processing in step S702, and redundant descriptions thereof will be omitted.

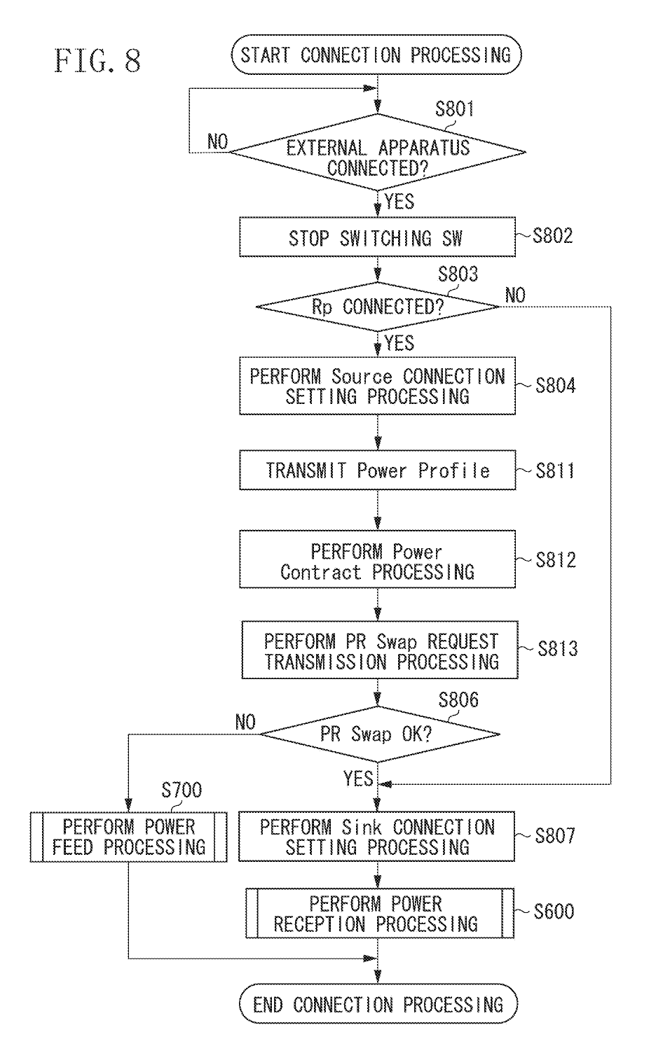

Upon completion of Power Contract in step S906, then in step S907, the system control unit 117 performs the power reception determination processing. When the system control unit 117 determines that the electronic apparatus 100 does not need to receive power in the power reception determination processing, the processing proceeds to step S700 for the power supply processing. It is assumed that the power supply processing in step S700 in FIG. 9 is similar to the processing in step S700 in FIGS. 5 and 8. Since the Power Profile transmission processing and the Power Contract processing are performed in step S905 and S906, respectively, these pieces of processing can be omitted in the power supply processing in step S700.

When the system control unit 117 determines that the electronic apparatus 100 needs to receive power in the power reception determination processing, the processing proceeds to step S908. Processing in steps S908 to S910 is similar to the processing in steps S505 to step S507, respectively, and redundant descriptions thereof will be omitted. After completion of the processing in step S910, the system control unit 117 performs the power reception processing in step S600.

According to the comparative example, power with a predetermined voltage is transmitted to the external apparatus 200 via the VBUS terminal 101a during a time period after the time when the external apparatus 200 is connected and the Source connection setting processing is performed and till the time when PR SWAP is performed.

The time period during which power with a predetermined voltage is transmitted from the electronic apparatus 100 to the external apparatus 200 according to the present exemplary embodiment is shorter than the time period during which power with a predetermined voltage is transmitted from the electronic apparatus 100 to the external apparatus 200 according to the comparative example. The time period during which unnecessary power is transmitted from the electronic apparatus 100 to the external apparatus 200 is shortened, making it possible to restrict the consumption of the battery 400. Therefore, in a case where the electronic apparatus 100 as a DRP apparatus connects with the external apparatus 200 in the DFP/Source state, it becomes possible to restrict the consumption of the built-in battery 400 by the power supplying to the external apparatus 200.

According to the first exemplary embodiment, the electronic apparatus 100 transmits the PR SWAP request signal to the external apparatus 200 immediately after the electronic apparatus 100 connects with the external apparatus 200 in the DFP/Source state. According to a second exemplary embodiment, when the electronic apparatus 100 connects with the external apparatus 200 in the DFP/Source state, the electronic apparatus 100 transmits the PR SWAP request signal to the external apparatus 200 after performing the Power Profile transmission processing and the Power Contract processing.

FIG. 8 is a flowchart illustrating connection processing performed by the electronic apparatus 100 according to the second exemplary embodiment. The schematic views and block diagrams illustrated in FIGS. 1 to 4 also apply to the present exemplary embodiment, and detailed descriptions thereof will be omitted.

The electronic apparatus 100 starts the connection processing when the electronic apparatus 100 is not connected with the external apparatus 200. Processing in steps S801 to S804, S806, and S807 are similar to the processing in steps S501 to S504, S506, and S507, respectively, according to the first exemplary embodiment, and redundant descriptions thereof will be omitted.

Upon completion of Source connection setting processing in step S804, the processing proceeds to step S811. In step S811, the system control unit 117 transmits Power Profile to the external apparatus 200 with which the electronic apparatus 100 connects. Then, the processing proceeds to step S812.

In step S812, the system control unit 117 performs Power Contract together with the external apparatus 200. Upon acquisition of information indicating power of which reception is requested by the external apparatus 200, transmitted from the connected external apparatus 200, the system control unit 117 completes the contract on the power transmission and reception.

In step S813, the system control unit 117 controls the communication control unit 115 to output the PR SWAP message to the connected external apparatus 200 via the CC terminal 101b. Then, the processing proceeds to step S806.

Even in a case where the electronic apparatus 100 as a DRP apparatus connects, as a Source, with the external apparatus 200 based on the USB Type-C standard, as in the second exemplary embodiment, the electronic apparatus 100 can perform PR SWAP to become a Sink immediately after completion of Power Contract. This processing reduces the opportunity of power supplying to the external apparatus 200, making it possible to restrict the consumption of the built-in battery 400.

While exemplary embodiments have been described, it is to be understood that they are not limiting. The scope of the following claims is to be accorded the broadest interpretation so as to encompass all such modifications and equivalent structures and functions.

This application claims the benefit of Japanese Patent Application No. 2016-254231, filed Dec. 27, 2016, which is hereby incorporated by reference herein in its entirety.

What is claimed is:

1. An electronic apparatus capable of connecting with an external apparatus and transmitting and receiving power to/from the external apparatus, the electronic apparatus comprising:
a first connection terminal connectable with the external apparatus;
a first resistor of which one end is connected to a terminal for outputting a first voltage;
a second resistor of which one end is connected to a terminal for outputting a second voltage lower than the first voltage;
a switching unit configured to switch between a first connection of the first connection terminal with an other end of the first resistor and a second connection of the first connection terminal with an other end of the second resistor; and
a communication unit configured to communicate with the external apparatus via the first connection terminal,
wherein, in a case that the first connection terminal is not connected with the external apparatus, the switching unit periodically switches between the first connection and the second connection,
wherein, in a case that the first connection terminal is connected with the external apparatus, the switching unit fixes a connection of the first connection terminal on either the first or the second connection, and
wherein, in a case that the switching unit fixes the connection of the first connection terminal on the first connection, the communication unit transmits, to the external apparatus, a request signal for requesting that the external apparatus enter a state where the external apparatus is capable of supplying power to the electronic apparatus.

2. The electronic apparatus according to claim 1, wherein after the switching unit fixes the connection of the first connection terminal on the first connection, the communication unit transmits the request signal without outputting, to the external apparatus, information indicating power suppliable to the external apparatus.

3. The electronic apparatus according to claim 1, further comprising:
a determination unit configured to determine whether the electronic apparatus needs to be supplied with power from the external apparatus,
wherein before the determination unit determines whether the electronic apparatus needs to be supplied with power from the external apparatus, the communication unit transmits the request signal to the external apparatus.

4. The electronic apparatus according to claim 1, wherein, immediately after the switching unit fixes the connection of the first connection terminal on the first connection, the communication unit transmits the request signal to the external apparatus.

5. The electronic apparatus according to claim 1, wherein the first voltage is 5 V, and the second voltage is a ground potential of the electronic apparatus.

6. The electronic apparatus according to claim 1, further comprising:
a second connection terminal connected with the external apparatus;
a power source connection unit connected with a power source and configured to transmit and receive power to/from the power source; and
a power control unit configured to control power transmission and reception between the power source connection unit and the external apparatus via the second connection terminal,
wherein in the case that the switching unit fixes the connection of the first connection terminal on the first connection, the power control unit performs control to transmit power with a predetermined voltage from the second connection terminal to the external apparatus, and
wherein in the case that the external apparatus enters a state where the external apparatus is capable of supplying power to the electronic apparatus, the power control unit performs control not to transmit power from the second connection terminal to the external apparatus.

7. The electronic apparatus according to claim 1, wherein when the communication unit receives, from the external apparatus, a signal indicating that the external apparatus makes a request for the electronic apparatus to enter a state where the electronic apparatus is capable of supplying power to the external apparatus after the communication unit receives, from the external apparatus, an acceptance signal indicating that the external apparatus accepts entering a state where the external apparatus is capable of supplying power to the electronic apparatus, the communication unit transmits a signal for rejecting the request.

8. The electronic apparatus according to claim 1, wherein in a case that the determination unit determines that the first connection terminal and the external apparatus are not connected in a state where the first connection is fixed, the switching unit resumes periodically switching between the first connection and the second connection.

9. The electronic apparatus according to claim 1, wherein the request signal is a PR SWAP request signal specified by a USB Type-C Power Delivery standard.

10. A method for controlling an electronic apparatus including a first connection terminal connectable with an external apparatus, a first resistor of which one end is connected to a terminal for outputting a first voltage, a second resistor of which one end is connected to a terminal for outputting a second voltage lower than the first voltage, and a switching unit configured to switch between a first connection of the first connection terminal with an other end of the first resistor and a second connection of the first connection terminal with an other end of the second resistor, the method comprising:
controlling the switching unit; and
communicating with the external apparatus via the first connection terminal,
wherein in a case that the first connection terminal is not connected with the external apparatus, the switching unit is controlled to periodically switch between the first connection and the second connection,
wherein in a case that the first connection terminal is connected with the external apparatus, the switching unit is controlled to fix a connection of the first connection terminal on either the first or the second connection, and
wherein in a case that the connection of the first connection terminal is fixed on the first connection in the controlling, a request signal for requesting that the external apparatus enter a state where the external apparatus is capable of supplying power to the electronic apparatus is transmitted to the external apparatus in the communicating.

11. The method for controlling the electronic apparatus according to claim 10, wherein after the connection of the first connection terminal is fixed on the first connection, the request signal is transmitted to the external apparatus without outputting information indicating power suppliable to the external apparatus by the electronic apparatus in the communicating.

12. The method for controlling the electronic apparatus according to claim 10, the method further comprising:
determining whether the electronic apparatus needs to be supplied with power from the external apparatus,
wherein before whether the electronic apparatus needs to be supplied with power from the external apparatus is determined in the determining, the request signal is transmitted to the external apparatus in the communicating.

13. The method for controlling the electronic apparatus according to claim 10, wherein immediately after the connection of the first connection terminal is fixed on the first connection in the controlling, the request signal is transmitted to the external apparatus in the communicating.

14. The method for controlling the electronic apparatus according to claim 10,
wherein in the case that the connection of the first connection terminal is fixed on the first connection in the controlling, the information indicating power suppliable to the external apparatus is output and information indicating power required by the external apparatus is acquired in the communicating, and
wherein after the information indicating power required by the external apparatus is acquired, the request signal is output in the communicating.

15. The method for controlling the electronic apparatus according to claim 10, wherein the first voltage is 5 V, and the second voltage is a ground potential of the electronic apparatus.

16. The method for controlling the electronic apparatus according to claim 10,
wherein the electronic apparatus further includes a second connection terminal connected with the external apparatus, and a power source connection unit connected with a power source and configured to transmit and receive power to/from the power source,
wherein the method for controlling the electronic apparatus further comprises power-controlling for controlling power transmission and reception between the power source connection unit and the external apparatus via the second connection terminal,
wherein in the case that the switching unit fixes the connection of the first connection terminal on the first connection, power control is performed to transmit power with a predetermined voltage from the second connection terminal to the external apparatus in the power-controlling, and
wherein when the external apparatus enters a state where the external apparatus is capable of supplying power to the electronic apparatus, power control is performed not to transmit power from the second connection terminal to the external apparatus in the power-controlling.

17. The method for controlling the electronic apparatus according to claim 10, wherein when a signal indicating that the external apparatus makes a request for the electronic apparatus to enter a state where the electronic apparatus is capable of supplying power to the external apparatus is received after an acceptance signal indicating that the external apparatus accepts to enter a state where the external apparatus is capable of supplying power to the electronic apparatus is received from the external apparatus in the communicating, a signal for rejecting the request is transmitted in the communicating.

18. The method for controlling the electronic apparatus according to claim 10, wherein in a case that it is determined in the determining that the first connection terminal and the external apparatus are not connected in a state where the first connection is fixed, the switching unit is controlled to resume periodically switching between the first connection and the second connection.

19. The method for controlling the electronic apparatus according to claim 11, wherein the request signal is a PR SWAP request signal specified by a USB Type-C Power Delivery standard.

20. The method for controlling the electronic apparatus according to claim 11, wherein in a case that the connection of the first connection terminal is fixed on the first connection in the controlling of the switching unit, a request signal for requesting the external apparatus to enter a state where the external apparatus is capable of supplying power to the electronic apparatus is not transmitted in the communicating.
